(19) United States
(12) Patent Application Publication
(10) Pub. No.: US 2017/0168923 A1
(43) Pub. Date: Jun. 15, 2017

(54) SYSTEM AND METHOD FOR CREATING A TEST APPLICATION

(71) Applicant: Appypie Inc., Walnut, CA (US)

(72) Inventors: Abhinav Girdhar, Walnut, CA (US); Subhash Rawat, Walnut, CA (US)

(21) Appl. No.: 14/965,838

(22) Filed: Dec. 10, 2015

(51) Int. Cl. G06F 11/36; G06F 9/44

(52) U.S. Cl. CPC G06F 11/3684; G06F 8/30

(57) ABSTRACT

System and method for creating a test application are disclosed. The application includes a test application. Input data is received from a user at a development platform. The input data corresponds to a web application designed by a user. The user provides customization options through the input data. The user may customize the design of the web application during development. An automated script is utilized to fetch the input data from a server and modify the input data into a predefined format. Executable files are created from the input data in a predefined format according to the preferences of the user. The executable files are created by a scripting language. The executable files are uploaded at the server and are run for generating testing application. The user may download (install) the testing app from the server.

### CROSS-REFERENCE TO RELATED APPLICATIONS AND PRIORITY

The present application does not claim priority from any patent application.

### TECHNICAL FIELD

The present disclosure in general relates to a web development. More particularly, the present disclosure provides the generation of a test application.

### BACKGROUND

Application (App) creation and development has gained a lot of popularity due technical advancement in electronic devices such as mobile phone, tablet and like. An app may be customized and created by using web based services. A user's request may be received at a server. At the server, scripting languages may be used for creating the app according to a user's preference(s). Commands of the script languages may be executed for an easy creation of the app.

One such methodology uses PHP scripts because of plurality of functionalities offered by the PHP script for providing web development. PHP scripts are widely used, as PHP code can be combined with HTML code with various templates. However, PHP when used for app creation, requires human intervention. The requirement of the human intervention results in more time and may also lead to human errors. The human errors may further end up in cost increment and may not be desirable.

### SUMMARY OF THE INVENTION

This summary is provided to introduce aspects related to system(s) and method(s) for creating a test application and the aspects are further described below in the detailed description. This summary is not intended to identify essential features of the claimed subject matter nor is it intended for use in determining or limiting the scope of the claimed subject matter.

The present disclosure relates to a method for creating a test application. The method being performed by one or more processors. The method comprises receiving input data from a user over a development platform. The input data corresponds to a web application designed by a user. The method further comprises fetching, through an automated script, the input data the in a predefined format to be used for creating the test application. The automated script checks at a predefined time interval, a reception of the web application. The method further comprises creating automatically, executable files from the input data in the predefined format by using a scripting language. The automatic creation is according to the check performed by the automated script regarding the reception of the web application. The method further comprises uploading the executable files, wherein the upload enables an installation of the testing application through the executable files.

The present disclosure also relates to a system for creating a test application. The system comprises a processor and a memory coupled to the processor. The memory storing a plurality of modules to be executed by the processor. The plurality of modules are configured to receive input data from a user over a development platform. The input data corresponds to a web application designed by a user. The plurality of modules are further configured to fetch, through an automated script, the input data the in a predefined format to be used for creating the test application, wherein the automated script checks at a predefined time interval, a reception of the web application and create automatically, executable files from the input data in the predefined format by using a scripting language. The automatic creation is according to the check performed by the automated script regarding the reception of the web application. The plurality of modules are configured to upload the executable files, wherein the upload enables an installation of the testing application through the executable files.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for creating a test application in a computing environment, in accordance with an embodiment of the present subject matter;

FIG. 2 illustrates modules of a system for creating the test application, in accordance with an embodiment of the present subject matter;

FIG. 3 illustrates a flow chart of method for creating the test application in the computing environment, in accordance with an embodiment of the present subject matter; and

FIG. 4 provides a details of steps involved in the method for creating the test application in the computing environment, in accordance with an embodiment of the present subject matter.

### DETAILED DESCRIPTION

While aspects of described system and method for creating a test application may be implemented in any number of different computing systems, environments, and/or configurations, the embodiments are described in the context of the following exemplary system.

The present description relates to creation of an application in a computing environment. The application includes a test application. Input data is received from a user at a development platform. The input data corresponds to a web application designed by a user. The user provides customization options through the input data. The user may customize the design of the web application during development. An automated script is utilized to fetch the input data from a server and modify the input data into a predefined format. Executable files are created from the input data in a predefined format according to the preferences of the user. The executable files are created by a scripting language. The executable files are uploaded at the server and are run for generating testing application. The user may download (install) the testing app from the server.

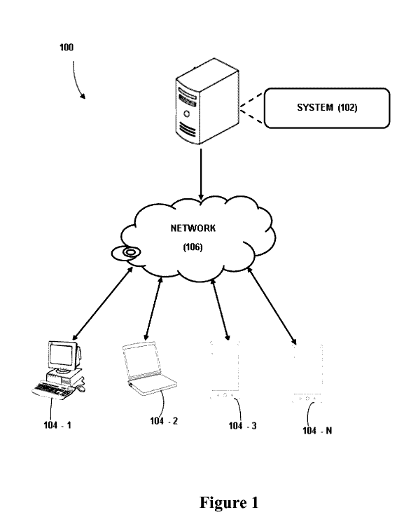

Referring now to FIG. 1, a network implementation 100 of system 102 for creating a testing application in a computing environment is shown. Although the present subject matter is explained considering that the system 102 is implemented as an application on a server, it may be understood that the system 102 may also be implemented in a variety of computing systems, such as a laptop computer, a desktop computer, a notebook, a workstation, a server, a network server, and the like. In one implementation, the system 102 may be implemented in a cloud-based environment. It will be understood that the system 102 may be accessed by multiple users through one or more user devices 104-1, 104-2 . . . 104-N, the user devices 104 collectively referred to as user device 104, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

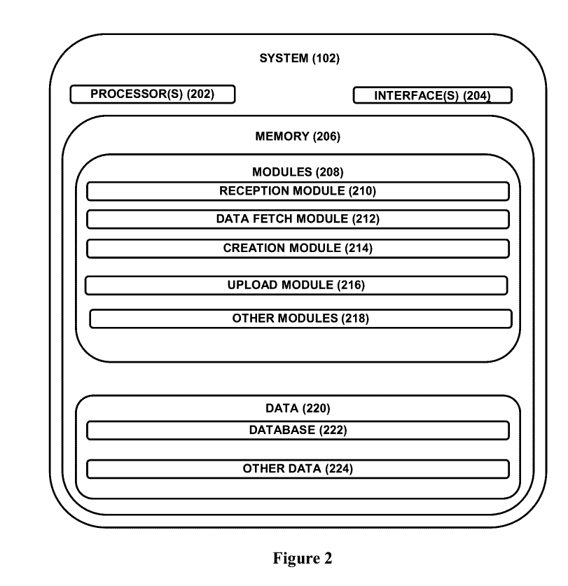

Referring now to FIG. 2, the system 102 is illustrated in accordance with an embodiment of the present subject matter. In one embodiment, the system 102 may include at least one processor 202, an input/output (I/O) interface 204 (herein a configurable user interface), a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 222.

The modules 208 include routines, programs, objects, components, data structures, etc., which perform particular tasks, functions or implement particular abstract data types. In one implementation, the modules 208 may include a reception module 210, a data fetching module 212, a creation module 214, and an upload module 216. Other modules 218 may include programs or coded instructions that supplement applications and functions of the system 102.

The data 220, amongst other things, serves as a repository for storing data processed, received, and generated by one or more of the modules. The data 220 may also include a database 222, and other data 224. The other data 224 may include data generated as a result of the execution of one or more modules.

The system 102 comprises a development platform provided to a user for designing the web application. The web application is designed based on pre-stored data at the web platform. The development platform comprises a web platform hosted over a server of the system 102. The server comprises a MAC server. The web platform allows the user to customize the design of the application through one or more web services.

The reception module 110 is configured to receive input data from a user. The input data corresponds to the web application designed by the user. The input data comprises at least one of a name of an App, splash and background screen, one or more icons, and content of the app. The input data provides a format of the web application designed by the user through the development platform.

The web platform provides web services to the user for deigning the web application. The web platform is hosted at the server of the system 102. The server comprises a MAC server and stores the web application designed by the user.

The data fetch 112 module then fetches the input data from the server. The data is fetched through an automated script. The automated script comprises a PHP script. The PHP script modifies the input data into a predefined format. The PHP script comprises an Application Programming Interface (API), programs and commands. The programs and commands fetches the data into the predefined format. The predefined format comprises an XML format. The PHP script checks at a predefined interval of time if there is any web application at the server. The web application designed by the user is associated with a request of creating a test application from the web application. The check by the PHP script improves the process of app creation by reducing time. The moment user designs the application, the PHP script starts working on the input data, thereby removing a need of any trigger from the user for creating the test app.

After the input data is fetched, the PHP script calls the scripting language (shell script) according to the checking of the web application. The shell script is called automatically by the modification module 112 once the automatic script checks the web application at the server designed by the user. The automatic calling of the shell script avoids a human intervention. The shell script is dependent upon a platform for which the app is to be created.

In accordance with an embodiment, the creation module 114 through the shell script perform one or more actions for creating executable files for one or more mobile platforms. The one or more mobile platforms may be chosen by the user under the one or more preferences of the user in the input data. The executable files comprises at least one of an .apk file, .ipa file, .xap file, and .bar executable files.

The shell script comprises one or more commands to read the input data in the XML format. The shell script copy resources and native project libraries from the input data in the XML format. The one or more commands of the shell script edit the XML files of the input data according to the one or more preferences of the user. The shell script converts the images into a required size as per the user's preference. The shell script reads the XML format files of the input data and converts the downloaded images from the input data into project required size to obtain project resources. The project resources are then modified to create executable files.

The upload module 216 is configured to upload the executable files at the server. The upload of the executable files allows the user to run the executable files for installing the testing application. After the executable files are uploaded, the upload module informs the server about a status of the creation of the test application. The status comprises one of a successful creation of the test app or an unsuccessful creation of the test app.

The steps performed by each of the module after the input data is received from the user is automatic. No human intervention is required in creating the testing app. The automation supported by the system in creating the app (testing app) reduces a possibility of human error and also reduces time. In an example, the time required by the system 102 for creating the app is in arrange of 2 minutes to 5 minutes as compared to a range of 30 minutes to 35 minutes of the prior art processes. The time is reduced due to automatic calling of the shell script and checking of the web application at the server by the PHP script.

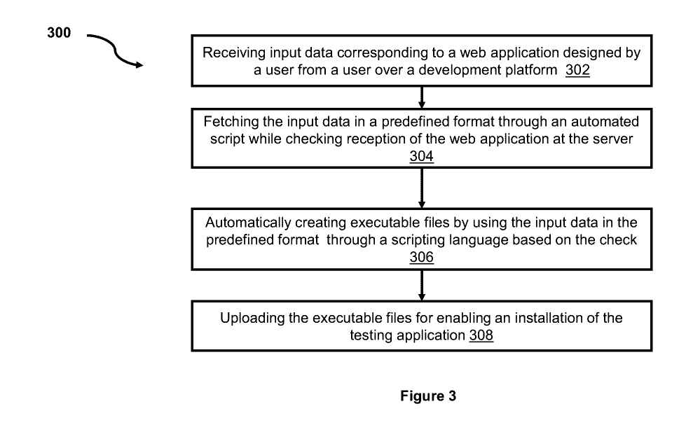

Referring now to FIG. 3, a method 300 for creating a testing application (app) in a computing environment is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 302, input data is received from a user over a development platform. The input corresponds to the web application designed by the user. In an example embodiment, the input data is received by the reception module 210.

At block 304, the input data is fetched in a predefined format through an automated script for creating the test application. The automated script checks at a predefined time interval, the web applications received at the server. In an example embodiment, the data is fetched through the data fetch module 212.

At block 306, the executable files are created automatically by using the input data in the predefined format by calling the scripting language. The automatic creation is according to the check performed by the automated script regarding the reception of the web application at the server. In an example embodiment, the executable files are created through the creation module 214.

At block 308, the executable files are uploaded at the server for enabling an installation of the test application by the user. In an example embodiment, the executable files are uploaded by the upload module 216.

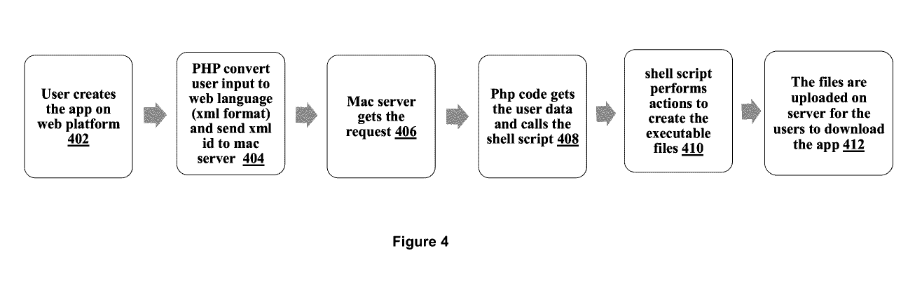

Referring to FIG. 4, an example embodiment for creating the test applications is shown. At step 402, the system 102 receives the input data received from the user designing the web application at the development platform. The development platform comprises a web platform. The web platform receives a request from the user for creating the app. The user may customize the design of the web application through the input parameters.

The PHP converts the user input to a web language i.e. the xml format and send the xml id to the mac server in step 404. The input parameters are stored with the server of the system 102 at step 406. The server comprises a MAC server. The MAC server receives the request of the user. The automated script gets the input data in the XML format and automatically calls the shell script at step 408. The automated script comprises the PHP code.

The PHP code scripts checks for request for the new app at a regular time interval. The regular time interval comprises every 2 minutes. The PHP code checks request for generation of new apps every 2 minutes.

The XML data is parsed by the PHP code and input data like images and icons are downloaded from the MAC server.

The shell script called by the PHP code copy the resources, reads the xml data and converts the downloaded images into the project required sizes. The shell script make the required changes in project resources of the input data for making the app user specific and with the user preferences and runs the commands and creates the executable files.

At step 410, the shell script comprises one or more commands and by executing the one or more commands, the shell script performs one or more actions according to the input data to create the executable files. An already available apk is used by the shell script for creating a new apk. The new apk is created by a reverse engineering method. The already available apk is un-compressed by the reverse engineering method by using an apk tool and an un-compressed folder is obtained. The converted resources and one or more necessary files are replaced in the un-compressed folder. The un-compressed folder is again compressed by using the apk tool in the apk format. The new apk so generated is signed with a keystore to make the new apk a valid apk.

The final apk i.e. the executable files are uploaded n the server for installation of the testing application.

The executable files are run for generating the test applications. The test applications are uploaded on the MAC server. The user may download or install the testing application from the server at step 412.

At step 412, the shell script calls the PHP to notify about a status of creation of the app. The status of the creation of app comprises one a successful creation of the app or an unsuccessful creation of the app. The PHP script updates the server regarding the status of creation of the app.

The written description describes the subject matter herein to enable any person skilled in the art to make and use the embodiments of the invention. The scope of the subject matter embodiments are defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

We claim:

1. A method for creating a test application, the method being performed by one or more processors, the method comprising:
receiving input data from a user over a development platform, wherein the input data corresponds to a web application designed by a user;
fetching, through an automated script, the input data the in a predefined format to be used for creating the test application, wherein the automated script checks at a predefined time interval, a reception of the web application;
creating automatically, executable files from the input data in the predefined format by using a scripting language, wherein the automatic creation is according to the check performed by the automated script regarding the reception of the web application; and
uploading the executable files, wherein the upload enables an installation of the testing application through the executable files.

2. The method as claimed in claim 1, wherein the input data comprises at least one of a name of the web application, splash/background screen, icons and content in the web application designed by the user over the development platform.

3. The method as claimed in claim 1, wherein the automated script comprise a PHP script, wherein the PHP script calls a shell level script, wherein the shell level script comprises shell scripting.

4. The method as claimed in claim 3, wherein the PHP script comprises an Application Programming Interface (API), programs and commands.

5. The method as claimed in claim 1, wherein the fetching comprises:
modifying the input data into an XML format; and
parsing the XML data for downloading at least one of an images and the icons in from the input data.

6. The method as claimed in claim 1, wherein the creating automatically comprises:
automatically calling for the scripting language by the automated script;
reading an XML format files of the input data and converting downloaded images from the input data into project required size to obtain project resources; and
modifying the project resources to create the executable files.

7. The method as claimed in claim 6, wherein the executable files comprises at least one of an .apk file, .ipa file, .xap file, and .bar executable files.

8. The method as claimed in claim 1, comprising:
updating the server regarding a status of the creation of the test application, wherein the status comprises one of a successful creation of the test application or an unsuccessful creation of the test application.

9. A system for creating a test application, the system comprising:
a processor; and
a memory coupled to the processor, wherein the memory storing a plurality of modules to be executed by the processor, and wherein the modules are configured to:
receive input data from a user over a development platform, wherein the input data corresponds to a web application designed by a user;
fetch, through an automated script, the input data the in a predefined format to be used for creating the test application, wherein the automated script checks at a predefined time interval, a reception of the web application;
create automatically, executable files from the input data in the predefined format by using a scripting language, wherein the automatic creation is according to the check performed by the automated script regarding the reception of the web application; and
upload the executable files, wherein the upload enables an installation of the testing application through the executable files.

10. The system as claimed in claim 9, wherein the input data comprises at least one of a name of the web application, splash/background screen, icons and content in the web application designed by the user over the development platform.

11. The system as claimed in claim 9, wherein the automated script comprise a PHP script, wherein the PHP script calls a shell level script, wherein the shell level script comprises shell scripting.

12. The system as claimed in claim 9, wherein the plurality of modules are configured to:
modify the input data into an XML format; and
parse the XML data for downloading at least one of an images and the icons in from the input data.

13. The system as claimed in claim 9, wherein the creating automatically comprises:
automatically call for the scripting language by the automated script;
read an XML format files of the input data and converting downloaded images from the input data into project required size to obtain project resources; and
modify the project resources to create the executable files.

14. The system as claimed in claim 13, wherein the executable files comprises at least one of an .apk file, .ipa file, .xap file, and .bar executable files.

15. The system as claimed in claim 9, wherein the plurality of modules are configured to:
update the server regarding a status of the creation of the test application, wherein the status comprises one of a successful creation of the test application or an unsuccessful creation of the test application.
